(19) United States
(12) Patent Application Publication
(10) Pub. No.: US 2018/0081681 A1
(43) Pub. Date: Mar. 22, 2018

(54) SYSTEMS AND METHODS TO REVERSE ENGINEER CODE TO MODELS USING PROGRAM ANALYSIS AND SYMBOLIC EXECUTION

(71) Applicant: GM Global Technology Operations LLC, Detroit, MI (US)

(72) Inventor: Ramesh Sethu, Troy, MI (US)

(21) Appl. No.: 15/268,011

(22) Filed: Sep. 16, 2016

(51) Int. Cl. G06F 9/44; G06F 11/36

(52) U.S. Cl. CPC G06F 8/74; G06F 8/75; G06F 11/3636; G06F 11/3608

(57) ABSTRACT

A system, for use in reverse-engineering initial input initial code to a high-level equivalent model. The system includes a hardware-based processing unit and a non-transitory computer-readable storage component including a function-extraction module that, when executed by the hardware-based processing unit (i) generates, based on the input initial code and an input variable list, a list of output and state transition functions per task; and (ii) generates, based on an input task table, a scheduler-automaton structure. The storage component also includes a function-modeling module that, when executed, generates, using the scheduler automaton and the list of output and state transition functions per task, the high-level equivalent model of the input initial code. Various aspects of the present technology includes the non-transitory computer-readable storage devices configured to perform the operations described, and processes including the operations performed by these systems, storage devices, and algorithms.

### TECHNICAL FIELD

The present disclosure relates generally to apparatus for reverse-engineering code to high-level models and, more particularly, to a tool and methodology to automatically reverse engineer code-level control applications into high-level models using advances in program analysis and symbolic-execution techniques.

### BACKGROUND

This section provides background information related to the present disclosure which is not necessarily prior art.

Computing systems of various types are developing in complexity to expand capabilities of linked apparatus such as vehicles of transportation, product development or analysis apparatus, manufacturing equipment, or warehouse logistics apparatus.

Legacy software systems are not able to take advantage of modern, model-based engineering.

### SUMMARY

There is a need for an automated tool for automatically reverse engineering legacy code-level control applications into high-level models.

The present technology accomplishes this and other needs using advances in program analysis and symbolic-execution techniques. In various embodiments, high-level model-generation includes taking advantage of an ability to trace routing or mapping or input source code, or traceability, for validation purposes.

Benefits include relieving personnel from laborious, time consuming, and error prone efforts to accomplish similar goals manually.

Benefits also include being able to employ modern, model-based engineering to resulting high-level models. The engineering approaches cannot be used with legacy code.

In one aspect, the present technology relates to a system, for use in reverse-engineering initial input initial code to a high-level equivalent model. The system includes a hardware-based processing unit and a non-transitory computer-readable storage component.

The storage component includes a function-extraction module that, when executed by the hardware-based processing unit (i) generates, based on the input initial code and an input variable list, a list of output and state transition functions per task; and (ii) generates, based on an input task table, a scheduler-automaton structure.

The storage component also includes a function-modeling module that, when executed by the hardware-based processing unit, generates, using the scheduler automaton and the list of output and state transition functions per task, the high-level equivalent model of the input initial code.

In various embodiments, the function-extraction module comprises (a) a task-slicing sub-module that, when executed, generates, based on the input task code and the input variable list, task output; and (b) a symbolic-execution-and-simplification sub-module that, when executed, generates, based on the task output, the list of output and state transition functions per task.

In some implementations, the function-extraction module includes a task-scheduling sub-module that, when executed, generates, based on the task table, scheduled-task output. In various embodiments, the sub-module, when executed, generates, based on the scheduled-task output, the scheduler-automaton structure.

The function-modeling module may include a template-based translation sub-module that, when executed, generates, based on the list of output and state transition functions per task, data-flow blocks as part of the function-modeling module generating the high-level equivalent model of the input initial code.

In various embodiments, the template-based translation sub-module, when executed: (A) determines a state of the list of output and state transition functions per task; and (B) determines a suitable state encoding to represent the state, in generating the data-flow blocks.

In some implementations, the template-based translation sub-module, when executed, determines, for each function of the state of the list of output and state transition functions per task, a basic block in a subject modeling language.

The template-based translation sub-module, when executed, can determine, for each function of the state of the list of output and state transition functions per task, the basic block using block semantics templates.

In various embodiments, the template-based translation sub-module, when executed, combines each basic block in generating the data-flow blocks.

In some cases, the function-modeling module comprises an automaton-encoding sub-module that, when executed, generates, based on the scheduler automaton, control-flow triggers as part of the function-modeling module generating the high-level equivalent model of the input initial code.

The automaton-encoding sub-module, when executed, may encode a state machine as a block of a subject modeling language in generating the control-flow triggers.

In various implementations, the function-modeling module includes (i) a template-based translation sub-module that, when executed, generates, based on the list of output and state transition functions per task, data-flow blocks; (ii) an automaton-encoding sub-module that, when executed, generates, based on the scheduler automaton, control-flow triggers; and (iii) a system-composition sub-module that, when executed, generates the high-level equivalent model based on the data-flow blocks and the control-flow triggers.

Various aspects of the present technology includes a non-transitory computer-readable storage devices configured to perform any of the operations described, algorithms to perform any of the operations described, and processes including the operations performed by these systems, storage devices, and algorithms.

Other aspects of the present technology will be in part apparent and in part pointed out hereinafter.

### DESCRIPTION OF THE DRAWINGS

FIG. 1 illustrates schematically an example hardware-based computing system, according to embodiments of the present technology.

FIG. 2 shows portions of the system of FIG. 1 in more detail, emphasizing example memory components.

FIG. 3 shows interactions between the various components of FIG. 2, including with external systems.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. Technology Introduction

The present disclosure describes, by various embodiments, apparatus and methods to address the issues above and improve computing systems and analysis thereof in various ways.

The solution involves a tool and methodology to automatically identify code patterns and converting them to high-level models. The tools and methodologies accomplish this goal using powerful symbolic-execution techniques.

Model-based development has many advantages, such as being more readily understood, being more easily abstracted, being easier to maintain, ability to revise, having a relatively high code quality, and others.

The technology includes, in various embodiments, for instance, a methodology and a tool for automatically reverse engineering code level control applications into high-level models using advances in program analysis and symbolic-execution techniques.

Partial or full models can be generated based upon user input, such as user-communicated preferences or selections.

In various embodiments, the methodology is independent of the source code and target modeling language(s).

In some implementations, the model generation can include traceability to the input source code for validation.

The technology enhances development productivity and quality of control systems implementation.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trolleys, trains, manufacturing equipment (for example, forklift), construction machines, and agricultural machinery, or of warehouse equipment, devices at the office, home appliances, personal or mobile computing devices, such as phones, wearables, plug-ins, and wireless peripherals, the like, and other.

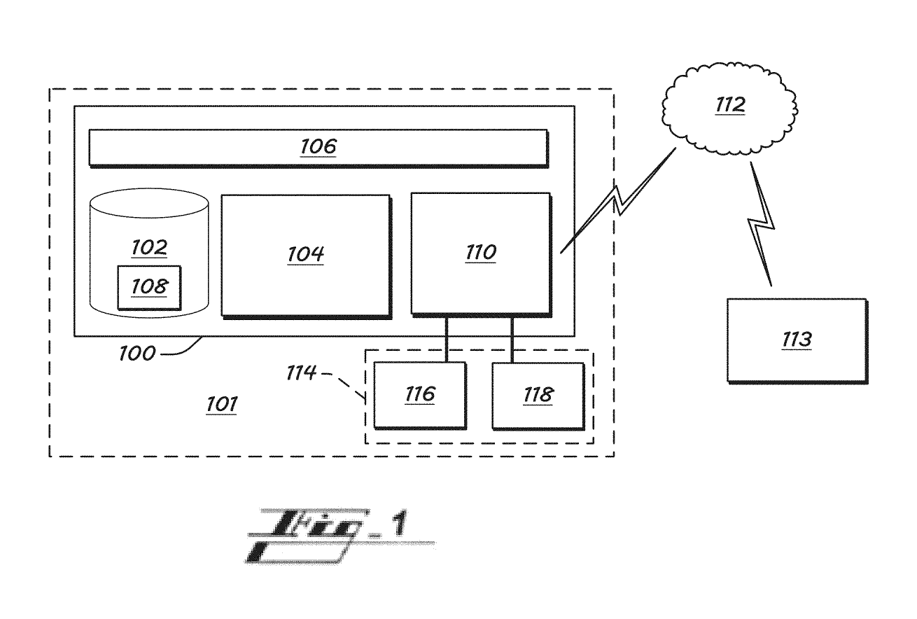

### II. Hardware-Based Computing System and Base Vehicle—FIG. 1

Turning now to the figures, and more particularly to the first figure, FIG. 1 shows an example hardware-based computer or computing system 100, for use in accordance with embodiments of the present disclosure.

The computer system 100 is in various embodiments part of a greater system 101, such as an automobile, server, or great computing system.

The computer system 100 can be implemented in any of a variety of ways, such as in the form of a server, within a mobile communications device, or other.

Although connections are not shown between all of the components illustrated in FIG. 1, the components can interact with each other to carry out system functions.

As shown, the computer system 100 includes a hardware-based memory, or computer-readable storage device 102, such as volatile medium, non-volatile medium, removable medium, and non-removable medium. The term computer-readable media and variants thereof, as used in the specification and claims, refer to tangible or non-transitory, computer-readable storage devices.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The computer system 100 also includes a processing hardware unit, or hardware-based processing unit, 104 connected or connectable to the computer-readable storage device 102 by way of a communication link 106, such as a computer bus.

The processing hardware unit can include or be multiple processors, which could include distributed processors or parallel processors in a single machine or multiple machines. The processing hardware unit can be used in supporting a virtual processing environment. The processing hardware unit could include a state machine, application specific integrated circuit (ASIC), programmable gate array (PGA) including a Field PGA, or state machine. References herein to the processing hardware unit executing code or instructions to perform operations, acts, tasks, functions, steps, or the like, could include the processing hardware unit performing the operations directly and/or facilitating, directing, or cooperating with another device or component to perform the operations.

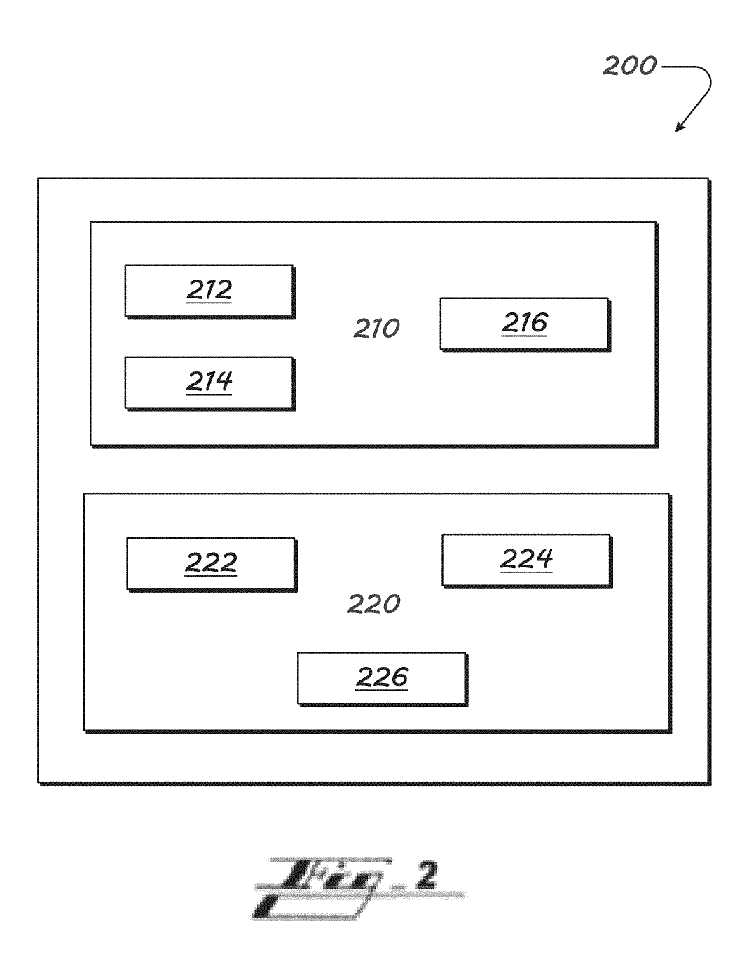

The computer-readable storage device 102 includes computer-executable instructions, or code 108, including executable modules (FIG. 2). The computer-executable instructions 108 are executable by the processing hardware unit 104 to cause the processing hardware unit, and thus the computer system 100, to perform any combination of the functions described in the present disclosure.

The computer system 100 further comprises an input/output (I/O) device 110, such as a wireless transceiver and/or a wired communication port. The processing hardware unit 104, executing the instructions 108, sends and receives information, such as in the form of messages or packetized data, to and from one or more communication networks 112, such as the Internet, and the devices they are connected to—remote servers, road-side infrastructure, other vehicles, mobile devices, etc.

In some embodiments, such as when the system 100 is implemented within a vehicle 102, the system 100 includes or is connected to one or more local input/output devices 114, including at least one local input device 116 and/or at least one local output device 118.

The inputs 116 can include vehicle sensors such as positioning system components (e.g., GPS receiver), speed sensors, and camera systems. The outputs 118 can include any automated control system of the vehicle, such as an autonomous or semi-autonomous driving system, or an HVAC system. The inputs and/or the outputs 116, 118 can include applications such as social-media, music, traffic, and weather applications installed at the vehicle 102.

By the external networks 112, such as the Internet, a local-area, cellular, or satellite network, vehicle-to-vehicle, pedestrian-to-vehicle, road-side infrastructure networks, the like or other, the computing system 100, or greater system—e.g., vehicle 101—can reach various computing apparatus 113 mobile or local systems or remote systems, such as remote servers.

Example mobile or local devices include user smartphones and a user wearable devices. Another example mobile or local device is a user plug-in device, such as a USB mass storage device, or such a device configured to communicate wirelessly.

Still another example mobile or local device is an on-board device (OBD), such as a wheel sensor, a brake sensor, an accelerometer, a rotor-wear sensor, a throttle-position sensor, a steering-angle sensor, a revolutions-per-minute (RPM) indicator, a brake-torque sensors, other vehicle state or dynamics-related sensor for the vehicle, with which the vehicle is retrofitted with after manufacture. The OBD(s) can include or be a part of a sensor sub-system or other input system, such as the inputs 116 referenced.

The computing system 100, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller are in other embodiments executed via similar or other message-based protocol.

### III. Additional System Components—FIG. 2

FIG. 2 shows example memory components of the computer-readable storage device 102, and more particularly example modules 200 of the code 108 thereof.

The modules 200 are configured for performing processes of the present disclosure. Any of the code or instructions described can be part of more than one module. And any functions described herein can be performed by execution of instructions in one or more modules, though the functions may be described primarily in connection with one module by way of primary example. Each of the modules and sub-modules can be referred to by any of a variety of names, such as by a term or phrase indicative of its function.

Sub-modules can cause the processing hardware-based unit 104 to perform specific operations or routines of module functions. Each sub-module can also be referred to by any of a variety of names, such as by a term or phrase indicative of its function.

Example modules 200 and constituent sub-modules include:
Function-extraction module 210
   Task-slicing sub-module 212;
   Symbolic-execution-and-simplification sub-module 214;
   Task-scheduling sub-module 216; and
Function-modeling module 220
   Template-based translation sub-module 222;
   Automaton-encoding sub-module 224; and
   System-composition sub-module 226.

The modules, sub-modules, and their functions are described more below.

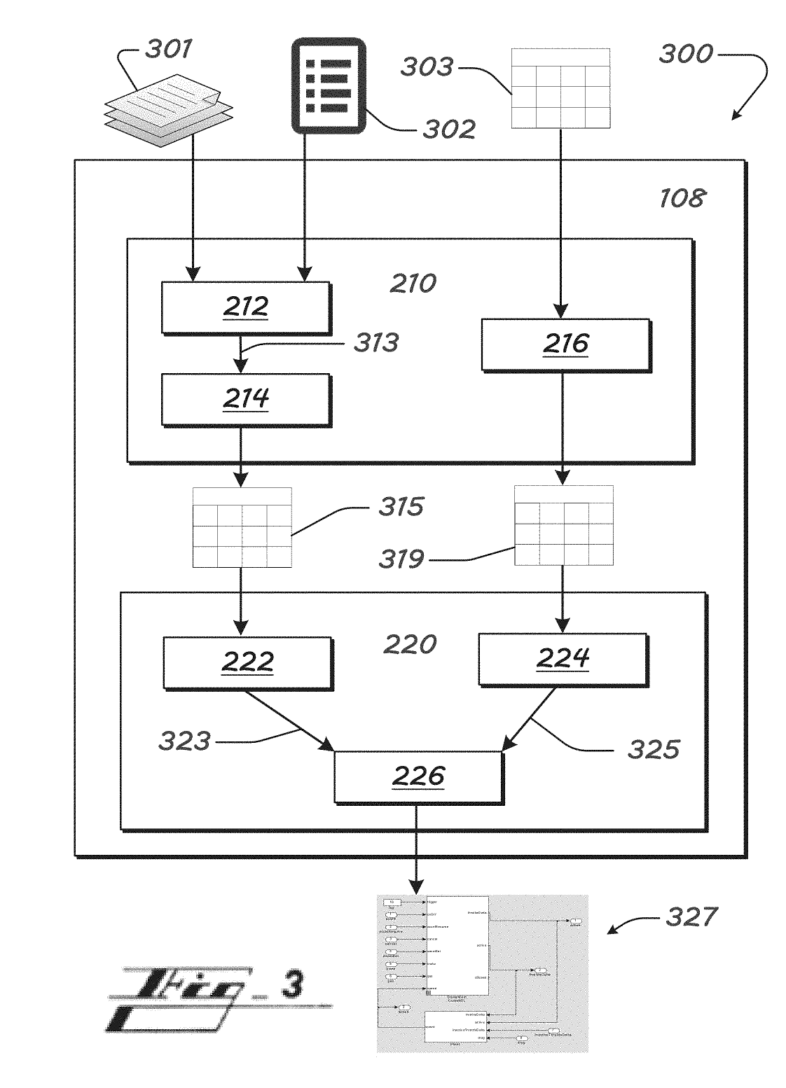

### IV. Algorithms and Processes—FIG. 3

IV.A. Introduction to the Algorithms

FIG. 3 shows an example algorithm, process, or routine represented schematically by a flow 300, according to embodiments of the present technology. The algorithms, processes, and routines are at times herein referred to collectively as processes or methods for simplicity.

Though a single flow 300 is shown for simplicity, any of the functions or operations can be performed in one or more or processes, routines, or sub-routines of one or more algorithms, by one or more devices or systems.

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit 104, a processing unit of an user mobile, and/or the unit of a remote device, executing computer-executable instructions stored on a non-transitory computer-readable storage device of the respective device, such as the data storage device 102 of the computing system 100, which in various embodiments is a part of a greater system 101 such as an automobile or other vehicle, for instance.

IV.B. System Components and Functions

FIG. 3 shows a view components of FIG. 2 interacting according to various exemplary algorithms of the present technology. The algorithms are illustrated in the form of a process flow 300.

As provided, the performing modules include the function-extraction module 210, which includes (i) the task-slicing sub-module 212, (ii) the symbolic-execution-and-simplification sub-module 214, and (iii) the task-scheduling sub-module 216.

One of multiple inputs to the function-extraction module 210 includes present, subject, or initial computer code 301 to be automatically reverse engineered.

In various embodiments, the initial code 301 includes one or more time- and/or event-triggered tasks. Example legacy code 301 is for vehicle-control applications, in a C language or legacy assembly-level code.

In various embodiments, the legacy code 301 consists of a set of event- or time-triggered tasks, each task including one or more standard C functions that are executed in an order specified in the task code. Further, each time-triggered task can be a periodic task whose period is specified, while each event-triggered task can be executed whenever a corresponding specified event occurs in the system. The event could be either generated internally, by other tasks, or externally, in an environment in which the system is implemented.

In various embodiments, there are tasks that are time-triggered, as well as being event-triggered.

The initial code 301 is input, more particularly, to the task-slicing sub-module 212 of the function-extraction module 210, as shown in FIG. 3.

Another of the multiple inputs to the function-extraction module 210 includes a variable list, or list of variables of interest, 302. The list in some implementations includes variables of interest from the input code 301. The variables include some or all of the input variables occurring in various functions called by the tasks in the input.

The variable list 302 is also input to the task-slicing sub-module 212 of the function-extraction module 210.

Another input to the function-extraction module 210 is a task table 303. The task table 303 in various embodiments includes scheduler information for the input code 301. The task table specifies the frequency with which the different tasks are executed and/or the events required for execution. An illustration of the table is Table 1, below.

The task table 303 is input to the task-scheduling sub-module 216 of the function-extraction module 210. The Task Table 303 is provided in the example form of a table, but can be provided in any suitable form for performing operations of the present process.

The following table (Table 1) is an example Task Table. The Task Table includes five (5) rows for tasks: Task 1 (T1), Task 2 (T2), Task 3 (T3), Task 4 (T4), Task 5 (T5); a column for Priority, a column for Time Trigger, and a column for Event Trigger.

TABLE 1

| Priority/Triggers | | | |
|---|---|---|---|
| vs. | | | |
| Tasks | Priority | Time Trigger | Event Trigger |
| T1 | 4 | 25 ms | Brake_pressed |
| T2 | 3 | 12.5 ms | |
| T3 | 1 | 3.125 ms | |
| T4 | 0 | | Door_open |

In this example, T4 has the highest priority, T3 has the next higher priority, T2 the next higher priority and T1 has the lowest priority. The time trigger specifies the periods of the tasks. For instance, T2 is executed every 25 ms. The event trigger specifies the events required for executing the task. For instance, T1 is executed every 25 ms whenever the event Brake_pressed event is present, whereas T4 requires the event Door_open for execution, and has no time trigger requirement.

The task-slicing sub-module 212, when executed by the hardware-based processing unit 104, receives the task code 301 and the variable list 302. The task-slicing sub-module 212 generates, based on the task code 301 and the variable list 302, first, or task, output 313. Given a variable list, the task-slicing sub-module 212 identifies all instructions in the task that either directly refer to these variables or indirectly refer to these variables through a chain of other variables that are either data or control dependent upon a variable in the input list. The slicing retains all those identified instructions and removes the other instructions to produce a smaller task. If there is a function call in the task, slicing is carried out recursively throughout an entirety of the chain of functions called.

The symbolic-execution-and-simplification sub-module 214, when executed by the hardware-based processing unit 104, receives the output 313 of the task-slicing sub-module 312. Based on the output, the symbolic-execution-and-simplification sub-module 214, generates a list of output and state transition function(s) per task 315. This second output 315 is described as a list in a non-limiting manner, as the output 315 may take any suitable form for use in the present process 300.

The symbolic-execution-and-simplification sub-module 214 assigns symbolic values, such as X, Y, for all of the input variables and executes all the instructions in the tasks/functions, successively computing expressions involving these symbolic values. At the end of this execution, all the state variables and the output variables will have the values as complex expressions involving the symbolic values and operators occurring in the function/tasks. These expression may also involve conditional statements.

A first example output function can be represented as follows:

Cruise_Speed(n+1)=Cruise_Speed(n)+1, if inc=1,cruise=1

Cruise_Speed(n)−1, if dec=1,cruise=1

Current_Speed(n+1), if set=1,cruise=1

Nil, if cruise=0

This function defines the output variable Cruise_Speed at an (n+1)^{th} step of a control cycle in terms of a value of variables at the n^{th} step. For example:
Cruise_Speed at the (n+1)^{th} step is incremented by 1, if an input event “inc”=1, and cruise is set at 1, meaning that cruise control function at the vehicle is turned on;
Cruise_speed is decremented by 1, if dec=1 and cruise is on. It is set to the current speed if set=1 and cruise is on; and
Cruise_speed is nil, if cruise is off (=0).

A second example output function can be represented as follows:

$$\begin{matrix}Parking\_Light = 1 , if Gear in Parking \\ = 0 , otherwise\end{matrix}$$

$$\begin{matrix}Window\_motor = - 1 , if window\_pos = top \\ = 1 , otherwise\end{matrix}$$

This example defines the output Parking_Light to be set to 1, indicating that the light is on, if Gear is in parking; else, if Gear is not in parking, Parking_Light is set to 0 (i.e., the light is switched off).

With continued reference to the function-extraction module 210, the task-scheduling sub-module 216, when executed by the hardware-based processing unit 104, receives the task table 303 and, using the task table 303, constructs the scheduler automaton 319. In various embodiments, this includes a scheduler automaton that periodically generates a set of trigger events, one for every period mentioned in the table 303. The periodic generation requires a set of states which are cycled through for generating the triggers.

The scheduler automaton output 319 can take the form of a table or chart, but can take other suitable forms without departing from the scope of the present technology.

The following table is an example scheduler-automaton table 319. The scheduler-automaton table shows a six (6) example states: S0, S1, . . . , S6, and their relation to tasks (T1 . . . T10).

| States | S0 | S1 | S2 | S3 | S4 |
|---|---|---|---|---|---|
| S0 | | T1, T2 | | T3 | |
| S1 | | | T6 | | |
| S2 | T5 | T4 | | | |
| S3 | | T7 | | T8 | |
| S4 | | | | | T10 |

This table describes the various state transitions in the schedule automaton 319. For instance, there is a transition from state S0 to S1, with the label T1 and T2, which represents the fact that the scheduler triggers the tasks T1 and T2 and transits from state S0 to the state S1.

With continued reference to FIG. 3 and the function-modeling module 220, the template-based translation sub-module 222, when executed by the hardware-based processing unit 104, receives the aforementioned list of output and state transition function(s) per task 315 from the symbolic-execution-and-simplification sub-module 214 of the function-extraction module 210.

Based on the list of output and state transition function(s) per task 315, the template-based translation sub-module 222, when executed by the hardware-based processing unit 104, translates the output and state transition functions per task of the list 315 to data-flow blocks 323. The data-flow blocks 323 are passed by the template-based translation sub-module 222 to the system-composition sub-module 226.

In various embodiments, operation of the template-based translation sub-module 222 is modeling-language dependent. The operation involves generating, choosing or otherwise determining a suitable state encoding to use to represent a subject state, or each subject state. For each basic function in the input initial code, for instance, the operation includes identifying or determining, using block semantics templates, a basic block in language of the initial code. In various embodiments, the operation also includes combining all of the basic blocks, yielding a data flow subsystem, or data-flow blocks, for each task. In some implementations, the operation also includes introducing a trigger for each task subsystem which will initiate the task computation.

The template-based translation chooses an appropriate functional block in the modeling language to realize the operation and hence it is modeling language dependent. For instance, if the target modeling language is Mathworks' Simulink/SF, then the functional blocks from the latter are used in the template. The operation and the corresponding functional block are part of a task in the input code and hence appropriate trigger event needs to be introduced in the model so that the block is triggered when the scheduler automaton generates this event. This ensures the correct realization of tasking semantics of the input code.

The automaton-encoding sub-module 224, when executed, receives the scheduler automaton 319 from the task-scheduling sub-module 216 of the function-extraction module 210. The automaton-encoding sub-module 224, based on the scheduler automaton 319, generates control-flow triggers 325. The operation of the automaton-encoding sub-module 224 includes encoding a state machine as a block in the modeling language. The operation can also include storing state information, and outputting various trigger signals corresponding to various states that trigger task subsystems, which output can be referred to as control-flow triggers. The template-based translation results in a set of triggered sub-systems, each of which is triggered by the scheduler automaton 319.

The system-composition sub-module 226, when executed, composes the data-flow blocks 323, and the scheduler automaton 319 generates the control-flow triggers 325, to produce a single model 327. This model 327 is in a modeling language chosen in the template-based translation and is equivalent in behavior to the initial task code 301. The high-level model 327 is in some implementations referred to as being equivalent, because the model 327 is fully or generally equivalent in behavior to the tasks in the input initial code.

As referenced, Mathworks Simulink/SF is just one example modeling language that can be used in connection with the reverse engineering. The template-based translation depends upon the chosen modeling language.

The process 300 can end or any one or more operations of the process can be performed again.

### V. Select Advantages

Many of the benefits and advantages of the present technology are described above. The present section restates some of those and references some others. The benefits described are not exhaustive of the benefits of the present technology.

The automated reverse engineering of software components provided by the present technology relieves modeling and software-development teams from performing laborious and time consuming attempts to reverse-engineer software components manually.

The automated reverse-engineering of the present technology is accurate and reduces required validation cycle time for such software and any electronic subsystems including the software. The accuracy enhances the quality of relate products—e.g., vehicle software reverse-engineered.

From a business perspective, productivity in product development is increased as a result of the automated reverse-engineering of the present technology.

The present technology is in some embodiments configured to allow any supporting personnel—modelers, system engineers, etc.—to initiate performance of the automated reverse-engineering by a simple selection, e.g., mouse or button click. This saves much time compared to conventional manual evaluation required.

The resulting software thus has a very high quality, and is obtained by less integration testing than conventionally needed.

Complex field failures typically arising out of complex software and integration options are reduced if not completely avoided.

The technology encourages reverse engineering of legacy systems to take advantage of model based engineering. Model-based development has many advantages, such as being more readily understood, being more easily abstracted, being easier to maintain, ability to revise, having a relatively high code quality, and others.

Partial or full models can be generated based upon user input, such as user-communicated preferences or selections.

In various embodiments, the methodology is independent of the source code and target modeling language(s).

In some implementations, the model generation can include traceability to the input source code for validation.

The technology enhances development productivity and quality of control systems implementation.

The technology adds uniformity to the process for applications development.

### VI. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for use in reverse-engineering initial input initial code to a high-level equivalent model, comprising:
a hardware-based processing unit; and
a non-transitory computer-readable storage component comprising:
a function-extraction module that, when executed by the hardware-based processing unit:
generates, based on the input initial code and an input variable list, a list of output and state transition functions per task; and
generates, based on an input task table, a scheduler-automaton structure; and
a function-modeling module that, when executed by the hardware-based processing unit, generates, using the scheduler automaton and the list of output and state transition functions per task, the high-level equivalent model of the input initial code.

2. The system of claim 1 wherein the function-extraction module comprises:
a task-slicing sub-module that, when executed, generates, based on the input task code and the input variable list, task output; and
a symbolic-execution-and-simplification sub-module that, when executed, generates, based on the task output, the list of output and state transition functions per task.

3. The system of claim 1 wherein the function-extraction module comprises a task-scheduling sub-module that, when executed:
generates, based on the task table, scheduled-task output; and
generates, based on the scheduled-task output, the scheduler-automaton structure.

4. The system of claim 1 wherein the function-modeling module comprises a template-based translation sub-module that, when executed, generates, based on the list of output and state transition functions per task, data-flow blocks as part of the function-modeling module generating the high-level equivalent model of the input initial code.

5. The system of claim 4 wherein the template-based translation sub-module, when executed:
determines a state of the list of output and state transition functions per task; and
determines a suitable state encoding to represent the state, in generating the data-flow blocks.

6. The system of claim 4 wherein the template-based translation sub-module, when executed, determines, for each function of the state of the list of output and state transition functions per task, a basic block in a subject modeling language.

7. The system of claim 6 wherein the template-based translation sub-module, when executed, determines for each function of the state of the list of output and state transition functions per task, the basic block using block semantics templates.

8. The system of claim 6 wherein the template-based translation sub-module, when executed, combines each basic block in generating the data-flow blocks.

9. The system of claim 1 wherein the function-modeling module comprises an automaton-encoding sub-module that, when executed, generates, based on the scheduler automaton, control-flow triggers as part of the function-modeling module generating the high-level equivalent model of the input initial code.

10. The system of claim 1 wherein the automaton-encoding sub-module, when executed, encodes a state machine as a block of a subject modeling language in generating the control-flow triggers.

12. The system of claim 1 wherein the function-modeling module comprises:
a template-based translation sub-module that, when executed, generates, based on the list of output and state transition functions per task, data-flow blocks;
an automaton-encoding sub-module that, when executed, generates, based on the scheduler automaton, control-flow triggers; and
a system-composition sub-module that, when executed, generates the high-level equivalent model based on the data-flow blocks and the control-flow triggers.

13. A non-transitory computer-readable storage device, for use in reverse-engineering initial input initial code to a high-level equivalent model, comprising:
a function-extraction module that, when executed by a hardware-based processing unit:
generates, based on the input initial code and an input variable list, a list of output and state transition functions per task; and
generates, based on an input task table, a scheduler-automaton structure; and
a function-modeling module that, when executed by the hardware-based processing unit, generates, using the scheduler automaton and the list of output and state transition functions per task, the high-level equivalent model of the input initial code.

14. The non-transitory computer-readable storage device of claim 13 wherein the function-extraction module comprises:
a task-slicing sub-module that, when executed, generates, based on the input task code and the input variable list, task output; and
a symbolic-execution-and-simplification sub-module that, when executed, generates, based on the task output, the list of output and state transition functions per task.

15. The non-transitory computer-readable storage device of claim 13 wherein the function-extraction module comprises a task-scheduling sub-module that, when executed:
generates, based on the task table, scheduled-task output; and
generates, based on the scheduled-task output, the scheduler-automaton structure.

16. The non-transitory computer-readable storage device of claim 13 wherein the function-modeling module comprises a template-based translation sub-module that, when executed, generates, based on the list of output and state transition functions per task, data-flow blocks as part of the function-modeling module generating the high-level equivalent model of the input initial code.

17. The non-transitory computer-readable storage device of claim 13 wherein the function-modeling module comprises an automaton-encoding sub-module that, when executed, generates, based on the scheduler automaton, control-flow triggers as part of the function-modeling module generating the high-level equivalent model of the input initial code.

18. The non-transitory computer-readable storage device of claim 13 wherein the automaton-encoding sub-module, when executed, encodes a state machine as a block of a subject modeling language in generating the control-flow triggers.

19. The non-transitory computer-readable storage device of claim 13 wherein the function-modeling module comprises:
a template-based translation sub-module that, when executed, generates, based on the list of output and state transition functions per task, data-flow blocks;
an automaton-encoding sub-module that, when executed, generates, based on the scheduler automaton, control-flow triggers;
a system-composition sub-module that, when executed, generates the high-level equivalent model based on the data-flow blocks and the control-flow triggers.

20. A method, for reverse-engineering initial input initial code to a high-level equivalent model, comprising:
generating, by a function-extraction module executed by a hardware-based processing unit, based on the input initial code and an input variable list, a list of output and state transition functions per task;
generating, by the function-extraction module executed by the processing unit, based on an input task table, a scheduler-automaton structure; and
generating, by a function-modeling module executed by the hardware-based processing unit, using the scheduler automaton and the list of output and state transition functions per task, the high-level equivalent model of the input initial code.
